(19) United States
(12) Patent Application Publication
(10) Pub. No.: US 2018/0132185 A1
(43) Pub. Date: May 10, 2018

(54) SMALL CELL AND ENERGY SAVING METHOD APPLIED THERETO

(71) Applicant: INDUSTRIAL TECHNOLOGY RESEARCH INSTITUTE, Hsinchu (TW)

(72) Inventors: Li-Chang WANG, Taipei City (TW); Yi-Bing LIN, Baoshan Township (TW)

(73) Assignee: INDUSTRIAL TECHNOLOGY RESEARCH INSTITUTE, Hsinchu (TW)

(21) Appl. No.: 15/392,757

(22) Filed: Dec. 28, 2016

(30) Foreign Application Priority Data
Nov. 9, 2016 (TW) 105136443

(51) Int. Cl. H04W 52/02; H04W 4/06

(52) U.S. Cl. CPC H04W 52/0241; H04W 52/0229; H04W 4/06

(57) ABSTRACT

An energy saving method applicable to a small cell is provided. The energy saving method includes the following steps. Determine whether or not to enter a dormant mode according to a loading information of the small cell. Periodically broadcast a reference signal in the dormant mode. Receive a handover request or a connection request to leave the dormant mode.

This application claims the benefit of Taiwan application Serial No. 105136443, filed Nov. 9, 2016, the disclosure of which is incorporated by reference herein in its entirety.

### TECHNICAL FIELD

The disclosure relates in general to an energy saving method, and to an energy saving method applied to a small cell.

### BACKGROUND

As the global warming effect has become severe, the world has paid more and more attention on the issue of carbon dioxide emission. In addition, with the increasing possibility of the lack of oil supply and the doubt in the safety of nuclear energy, effective management of energy consumption has also become more and more important. According to statistics, 2% of carbon dioxide emission and 10% of energy consumption come from the information and communication technology industry each year. As mobile network and mobile computing are increasingly popular, the data shows a trend of growth in double in every four years. In the mobile network, the network equipment consumes about 70%-90% of the total energy consumption. In the operation cost of a telecommunication provider, about 57% of the electricity charge comes from the base station. It is therefore one of the major concerns in the industry regarding how to effectively save energy consumption in the base station.

### SUMMARY

The disclosure relates to a small cell and an energy saving method applied thereto.

According to one embodiment, an energy saving method applicable to a small cell is provided. The energy saving method includes the following steps. Determine whether or not to enter a dormant mode according to a loading information of the small cell. Periodically broadcast a reference signal in the dormant mode. Receive a handover request or a connection request to leave the dormant mode.

According to another embodiment, a small cell is provided. The small cell includes a processor and a communication circuit. The communication circuit is configured to periodically broadcast a reference signal in a dormant mode, and configured to receive a handover request and a connection request. The processor is configured to determine whether or not to enter the dormant mode according to a loading information of the small cell, and configured to leave the dormant mode according to the handover request or the connection request.

### BRIEF DESCRIPTION OF THE DRAWINGS

FIG. 1 shows a diagram illustrating architecture of a communication system according to one embodiment of the disclosure.

FIG. 2 shows a flowchart of an energy saving method according to one embodiment of the disclosure.

FIG. 3 shows a diagram of a small cell according to one embodiment of the disclosure.

FIG. 4 shows an operation timing diagram according to one embodiment of the disclosure.

FIG. 5 shows a flowchart of an energy saving method according to one embodiment of the disclosure.

FIG. 6 shows a sequence diagram illustrating operations in the communication system according to one embodiment of the disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

In a communication system, base stations may be categorized into macro cells and small cells based on the coverage of the base stations. The macro cell provides basic communication service for user equipments (UE). The small cell is commonly used for providing hot spot service in order to improve the signal coverage in the communication system. The macro cell and the small cell may both be connected to the core network via the backhaul network, such as transmitting the communication data between the base station and the user equipment to the core network. Take long term evolution (LTE) technology for example, the macro cell may be an evolved node B (eNB), the small cell may be a home evolved node B (HeNB), such as a femtocell, and the core network may be an evolved packet core (EPC).

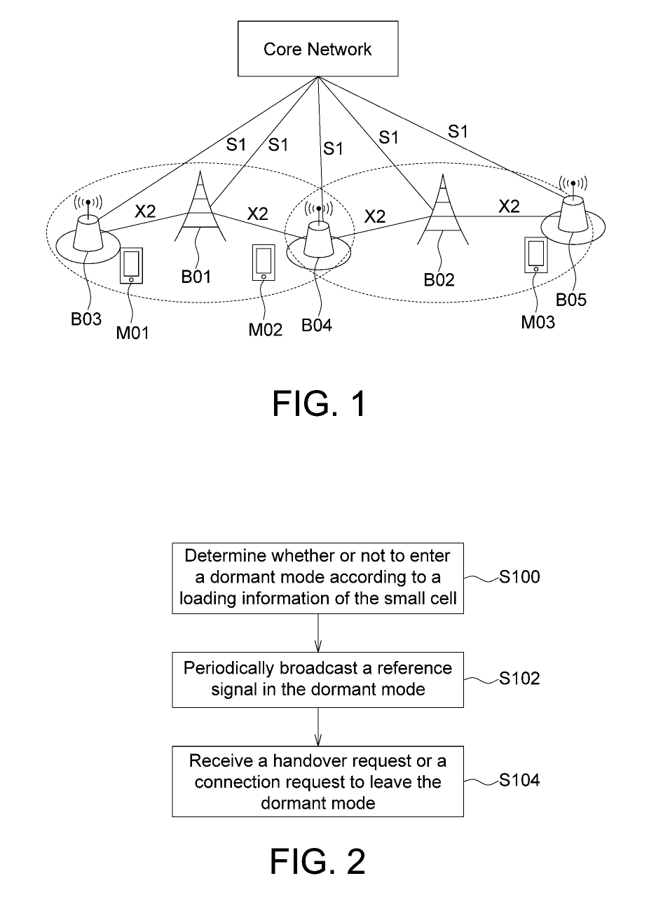

FIG. 1 shows a diagram illustrating architecture of a communication system according to one embodiment of the disclosure. The communication system includes macro cells B01 and B02, small cells B03, B04, and B05, and user equipments M01, M02, and M03. The base stations B01-1305 may be connected to the core network via the S1 interface, and the base stations B01-B05 may communicate with each other via the X2 interface. In FIG. 1, dashed line circles represent the coverage of each macro cell, and solid line circles represent the coverage of each small cell. When there are plenty of user equipments in the system, both the macro cell and the small cell have to be activated to provide adequate service quality for all the users. On the other hand, when the number of user equipments drops to a certain degree, only the macro cells are needed to provide adequate service quality. Keeping normal activation of the small cells in such situation may result in excess energy waste.

An energy saving mechanism has been provided in the 3rd generation partnership project (3GPP) standard. The energy saving method in the 3GPP standard includes the following steps. The macro cell transmits a resource status indication to the small cell via the X2 interface. If the small cell identifies that the current loading of the macro cell is low (the macro cell is able to serve more user equipments), the small cell may handover its serving user equipments to the macro cell. Then the small cell uses the configuration update message of the X2 interface to inform the macro cell that the small cell is about to enter a dormant mode for saving energy consumption. When the loading of the macro cell increases, the macro cell needs other base station to assist in providing service. Then the macro cell may use the base station activation request of the X2 interface to wake up the small cell currently in the dormant mode.

There may be some problems in the above described energy saving mechanism. For example, because the macro cell does not know the location of the small cell, after the small cell wakes up, there may be no user equipment in the coverage of the small cell. The current loading of the macro cell is still high in this situation, and thus the small cell cannot return to the dormant mode and has to remain in normal operation, resulting in unnecessary energy consumption. This will be referred as small cell user detection problem in the following description. In addition, the above described energy saving mechanism is realized via the X2 interface. However, the X2 interface between the base stations does not necessarily exist. For example, there may be no X2 interface between the base stations manufactured by different manufacturers. Thus there is a need for an energy saving method that may be realized even if the X2 interface does not exist.

Furthermore, in the above described 3GPP energy saving mechanism, when the small cell recognizes there is no user to serve, the small cell asks the macro cell about the loading of the macro cell. If the loading of the macro cell is heavy, the small cell may not enter the dormant mode. However, in this situation, whether or not the small cell sleeps does not affect the loading of the macro cell. The above described 3GPP energy saving mechanism does not permit the small cell to sleep in this situation, making the small cell consume unnecessary energy.

FIG. 2 shows a flowchart of an energy saving method according to one embodiment of the disclosure. The energy saving method applicable to the small cell includes the following steps. Step S100: Determine whether or not to enter a dormant mode according to a loading information of the small cell. Step S102: Periodically broadcast a reference signal in the dormant mode. Step S104: Receive a handover request or a connection request to leave the dormant mode. The handover request may come from another base station or the core network. The connection request may come from user equipments.

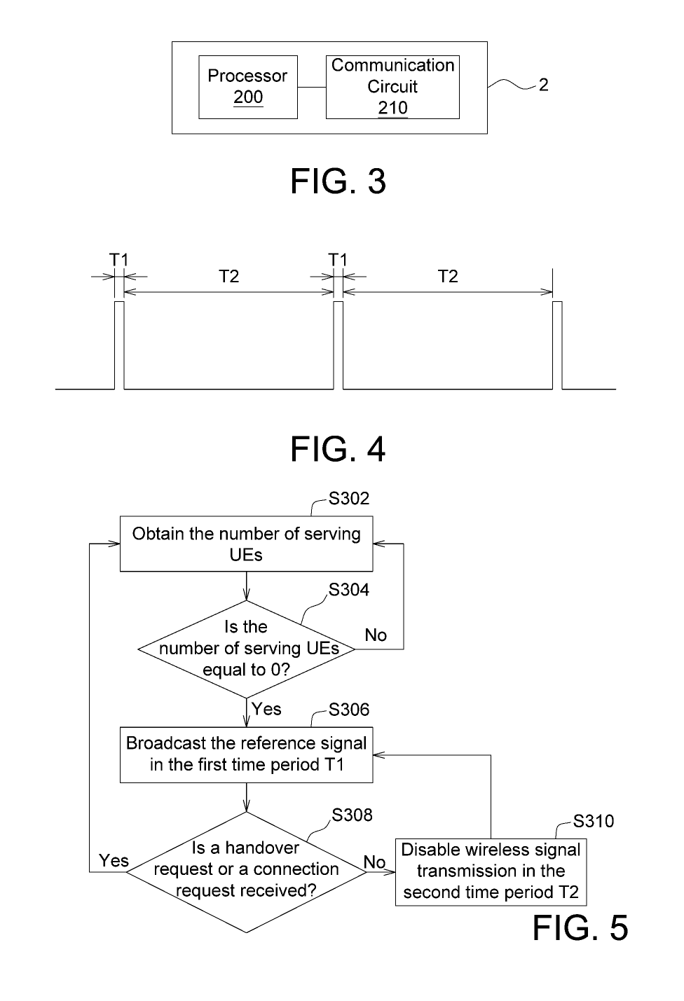

FIG. 3 shows a diagram of a small cell according to one embodiment of the disclosure. Reference is also made to the steps shown in FIG. 2. The small cell 2 includes a processor 200 and a communication circuit 210. The communication circuit 210 is configured to periodically broadcast a reference signal in a dormant mode (step S102), and configured to receive a handover request and a connection request (step S104). The processor 200 is configured to determine whether or not to enter the dormant mode according to a loading information of the small cell 2 (step S100), and configured to leave the dormant mode according to the handover request or the connection request (step S104). The processor 200 may be for example a microprocessor or a microcontroller, capable of performing logic and arithmetic operations. The communication circuit 210 may include for example wired interface communication circuit and wireless interface communication circuit, capable of establishing connection and communication with user equipments, other base stations, and the core network. The detailed description for each step is given below.

Step S100, the small cell 2 may evaluate its own current loading. When the current loading is low or near no loading at all, the small cell 2 may enter the dormant mode without affecting users. Thus the small cell 2 may determine to enter the dormant mode when the loading is low. In one embodiment, the loading information may be determined according to the number of user equipments served by the small cell 2. The more the user equipments currently connected to the small cell 2, the higher the loading of the small cell 2 is. In addition, the small cell 2 may also evaluate its loading based on the current data transmission bandwidth in the air interface. The loading information is not limited to being determined by the number of serving user equipments.

In one embodiment, the condition that the processor 200 determines to enter the dormant mode may be: when the number of user equipments served by the small cell 2 is equal to zero. Because when there is no user equipment to serve, it is guaranteed that no user equipment is affected if the small cell 2 enters the dormant mode and the communication service of all user equipments may be maintained. In another embodiment, a serving user equipment count lower bound Th1 may be set. The processor 200 determines to enter the dormant mode when the processor 200 evaluates that the number of user equipments currently served is below the serving user equipment count lower bound Th1. Similarly, a lower bound may be set for the transmission bandwidth to determine when to enter the dormant mode if the loading information is determined according to the data transmission bandwidth.

Step S102, the small cell 2 periodically “wakes up” to broadcast the reference signal. In the time durations not broadcasting the reference signal, the small cell 2 keeps in a minimum energy usage state. That is, the small cell 2 effectively stops operation in these time durations to save energy consumption. The purpose of broadcasting reference signal is that the user equipment may detect the existence of the small cell 2 even if the small cell 2 is in the dormant mode. For example, in the LTE system, the reference signal broadcasted by the communication circuit 210 may be the cell reference signal (CRS), which allows the user equipment to detect the small cell 2. In different communication system architecture, the reference signal may have different signal configurations. The energy saving method proposed in this disclosure is not limited to application in the LTE system.

In one embodiment, the dormant mode includes a first time period T1 and a second time period T2 periodically. The small cell 2 is configured to broadcast the reference signal in the first time period T1, and the small cell 2 is configured to disable wireless signal transmission in the second time period T2. The first time period T1 is the time duration that the small cell 2 briefly wakes up, such that the user equipment may detect the existence of the small cell 2. The second time period T2 is the time duration that the small cell 2 rests, stopping all wireless signal transmission (neither transmits signal nor receives wireless signal from other devices) to save energy consumption.

For example, the length of the second time period T2 may be larger than the length of the first time period T1. As such, the small cell 2 may reduce significant energy consumption in the dormant mode. FIG. 4 shows an operation timing diagram according to one embodiment of the disclosure. According to the pulse waveform shown in FIG. 4, the first time period T1 represents the brief time duration that the small cell 2 broadcasts the reference signal. The small cell 2 stops operation and rests in the remaining time duration. Because the small cell 2 only consumes energy in the first time period T1, the energy saving factor may be calculated as

$$\frac{T 2}{T 1 + T 2} .$$

The larger the ratio of the length of the second time period T2 to the length of the first time period T1, the higher energy saving factor may be achieved. In one embodiment, the length of the second time period T2 is at least ten times of the length of the first time period T1.

Transmission of the reference signal allows the user equipment to detect the existence of the small cell 2. Therefore in one embodiment, the length of the first time period T1 is at least one measurement gap repetition period. Take the LTE system for example, the measurement gap repetition period is for example 40 ms or 80 ms. The length of the first time period T1 may also be set as greater than or equal to 40 ms or 80 ms. In another embodiment, the first time period T1 may be increased to allow a new user equipment for establishing connection. The second time period T2 may represent how long can be tolerated for the small cell 2 to rest. For example, how long is tolerable for the user equipment in the system being unable to find a small cell providing service. In one embodiment, the length of the second time period T2 is at least 5 seconds to achieve a better energy saving effect, and also to keep the waiting time for a user equipment for searching service in a reasonable range. For example, the first time period T1=0.5 s, the second time period T2=5 s, then the

$$energy saving factor = \frac{5}{0.5 + 5} = 90.9 \% .$$

The description about the step S104 is given below. When the loading of a macro cell (take the macro cell B01 in FIG. 1 for example in this embodiment) becomes high, the macro cell B01 informs the serving user equipment (take the user equipment M01 in FIG. 1 for example in this embodiment) to search other base stations that provide service. The macro cell B01 does not necessarily ask each user equipment to perform signal measurement. Some criteria may be used to determine which user equipments are required to perform signal measurement. The criteria may include: the wireless resource consumed by the user equipment, the signal strength of the macro cell measured by the user equipment (for example, the user equipment may be connected to the macro cell, but the measured signal strength of the macro cell may be weak).

When a small cell (take the small cell B03 in FIG. 1 for example in this embodiment, the architecture of the small cell B03 may be referred to FIG. 3) is in the dormant mode, if the user equipment M01 needs service, the user equipment M01 scans the surrounding small cells. This scanning procedure is an existing procedure defined in the 3GPP standard. When the user equipment M01 detects that the signal strength of the reference signal transmitted by the small cell (the small cell B03 broadcasts the reference signal in the first time period T1) is large enough, if the user equipment M01 is about to establish a new connection, the user equipment M01 sends a connection request to the small cell B03. The communication circuit 210 in the small cell B03 may be configured to receive the connection request. The processor 200 may be configured to determine that the small cell B03 leaves the dormant mode when receiving the connection request.

In another scenario, when the user equipment M01 detects that the signal strength of the reference signal transmitted by the small cell B03 is large enough, if the user equipment M01 has already established connection to the macro cell B01, the user equipment M01 reports such information to the macro cell B01 (informs the macro cell B01 that the small cell B03 is able to provide service). The macro cell B01 may then transmit a handover request to the small cell B03 in order to handover the user equipment M01 to the small cell B03. The communication circuit 210 in the small cell B03 may be configured to receive the handover request, and the processor 200 may be configured to determine that the small cell B03 leaves the dormant mode when receiving the handover request. The above described two scenarios of establishing connection and performing handover belong to the random access and handover procedures in the LTE standard.

In detail, after multiple user equipments served by the macro cell B01 scan the surrounding small cells, the user equipments may report the measurement results to the macro cell B01. The macro cell B01 determines to handover which user equipments to other base stations according to the following criteria: the measured signal strength of the base station, the amount of consumed wireless resource, the base station that is detected by multiple user equipments. For example, if a specific base station is detected by multiple user equipments, the macro cell B01 may handover these user equipments to this specific base station to reduce a great amount of loading of the macro cell B01.

It is noted that in the above described procedure, the operations of the macro cell B01 and the user equipment M01 are the same as the current existing standard. In other words, from the perspective of the macro cell B01 and the user equipment M01, because the small cell B03 receives the handover request or the connection request to leave the dormant mode, the procedure of waking up the small cell B03 is effectively the same as the user equipment handover process or connection establishment process in the existing standard. The macro cell B01 and the user equipment M01 do not know that the small cell B03 is currently in the dormant mode. The user equipment M01 establishes connection based on the detected reference signal, or the user equipment M01 reports a target base station for handover to the macro cell B01 to perform handover procedure. Therefore, by adopting the energy saving method proposed in this disclosure, the existing standard does not have to be modified, and the design of the macro cell and the user equipment may also remain the same. Only a slight modification has to be made to the small cell, for example, when the small cell enters the dormant mode, the second time period T2 of sleep time is added (the step S102 in FIG. 2). As such, the energy saving method applied to the small cell may be realized by the existing connection process or handover operations.

Furthermore, because the user equipment M01 finds the neighboring small cell B03 by detecting the reference signal, the small cell B03 to be awoken up is guaranteed to be able to provide service to the user equipment M01. Thus the situation that the awoken small cell fails to provide service and consumes excess energy may be avoided, effectively overcoming the small cell user detection problem.

The handover request may include an S1 handover request and an X2 handover request. The handover request received by the small cell B03 may be received via the S1 interface of the small cell B03 or received via the X2 interface of the small cell B03. Referring to FIG. 1, in an example that the macro cell B01 sends a handover request to the small cell B03, the macro cell B01 may first send via the S1 interface to the core network, and then send via the S1 interface to the small cell B03. Alternatively, the macro cell B01 may send directly to the small cell B03 via the X2 interface. The communication circuit 210 may include data transmission interface circuit for the S1 interface and the X2 interface. In one embodiment, because the handover request is sent via the S1 interface, the energy saving method proposed in this disclosure may be applied to a communication system where no X2 interface exists.

FIG. 5 shows a flowchart of an energy saving method according to one embodiment of the disclosure. In this example, the loading of the small cell is determined based on the number of serving user equipments. The energy saving method in this embodiment includes the following steps. Step S302: Obtain the number of serving UEs. The small cell is now in the normal operation mode. The step S302 may be executed periodically. Step S304: Determine whether or not the number of serving UEs is equal to 0. If not, go back to the step S302 to obtain the loading information periodically. If yes, enter the dormant mode (steps S306-S310). In the dormant mode, step S306 broadcasts the reference signal in the first time period T1. Step S308 determines whether or not a handover request or a connection request is received. If yes, leave the dormant mode and go back to the step S302. If not, proceed to step S310, disable wireless signal transmission in the second time period T2 to reduce energy consumption of the small cell. In the dormant mode, energy consumption is only apparent in the step S306. Because the first time period T1 is much shorter than the second time period T2, a good energy saving effect may be achieved.

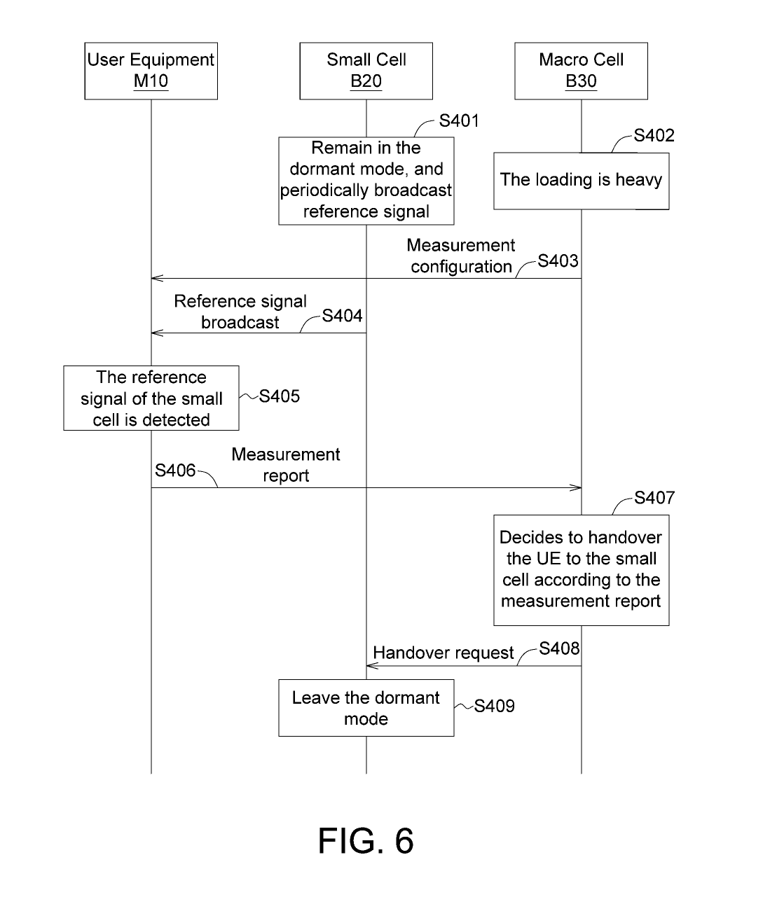

FIG. 6 shows a sequence diagram illustrating operations in the communication system according to one embodiment of the disclosure, for describing the process flow when a small cell receives the handover request. In this example the communication system includes a user equipment M10, a small cell B20, and a macro cell B30. First, in step S401 the small cell B20 remains in the dormant mode and periodically broadcasts the reference signal. Next, in step S402 the loading of the macro cell B30 increases. The macro cell B30 has to handover its serving user equipments to other base stations. Thus step S403 is executed, by utilizing a measurement procedure defined in the existing standard, the macro cell B30 sends a measurement configuration to the user equipment M10, such that the user equipment M10 reports the neighboring signal condition.

The small cell B20 continues to broadcast the reference signal, and thus transmits the reference signal to the user equipment M10 in step S404. The user equipment M10 detects the reference signal of the small cell B20 in step S405. The user equipment M10 reports the measurement report to the macro cell B30 in step S406. In step S407, based on the measurement report, the macro cell B30 decides to handover the user equipment M10 to the small cell B20 whose signal has been detected. In step S408, the macro cell B30 sends a handover request to the small cell B20 via the S1 interface or the X2 interface. The small cell B20 receives the handover request to leave the dormant mode in step S409, thus being able to provide service to the user equipment M10.

According to the small cell and the energy saving method applied thereto in this disclosure, the small cell only has to wake up briefly in the dormant mode to broadcast the reference signal, and therefore energy may be saved effectively. Because the user equipment detects the reference signal broadcasted by the small cell, and the small cell leaves the dormant mode by receiving the handover request or the connection request, it is guaranteed that the awoken small cell is able to provide service to the user equipment, effectively overcoming the small cell user detection problem. Furthermore, the energy saving method in the disclosure may be accomplished without modifying the existing standard or modifying the design for macro cell or user equipment. Because the handover request may be transmitted via the S1 interface, the energy saving method may be executed even if there is no X2 interface. The method in this disclosure may be realized by simply adding the sleep time of the second time period T2 and utilizing the existing S1 interface, connection procedure, and handover procedure.

That various modifications and variations may be made to the disclosed embodiments. It is intended that the specification and examples be considered as exemplary only, with a true scope of the disclosure being indicated by the following claims and their equivalents.

What is claimed is:

1. An energy saving method applicable to a small cell, comprising:
determining whether or not to enter a dormant mode according to a loading information of the small cell;
periodically broadcasting a reference signal in the dormant mode; and
receiving a handover request or a connection request to leave the dormant mode.

2. The energy saving method according to claim 1, wherein the loading information is determined according to a number of user equipments served by the small cell.

3. The energy saving method according to claim 2, wherein the step of determining whether or not to enter a dormant mode according to loading information of the small cell comprises:
entering the dormant mode when the number of user equipments served by the small cell is equal to zero.

4. The energy saving method according to claim 1, wherein the reference signal is a cell reference signal that allows a user equipment to detect the small cell.

5. The energy saving method according to claim 1, wherein the dormant mode comprises a first time period and a second time period periodically, the small cell is configured to broadcast the reference signal in the first time period, and the small cell in configured to disable wireless signal transmission in the second time period.

6. The energy saving method according to claim 5, wherein length of the second time period is larger than length of the first time period.

7. The energy saving method according to claim 5, wherein length of the first time period is at least one measurement gap repetition period.

8. The energy saving method according to claim 5, wherein length of the second time period is at least 1 second.

9. The energy saving method according to claim 1, wherein the handover request is received by an S1 interface of the small cell.

10. The energy saving method according to claim 1, wherein the handover request is received by an X2 interface of the small cell.

11. The energy saving method according to claim 1, wherein the small cell receives a connection request from a user equipment to leave the dormant mode.

12. A small cell, configured to perform an energy saving method, the small cell comprising:
a communication circuit, configured to periodically broadcast a reference signal in a dormant mode, and configured to receive a handover request and a connection request; and
a processor, configured to determine whether or not to enter the dormant mode according to a loading information of the small cell, and configured to leave the dormant mode according to the handover request or the connection request.

13. The small cell according to claim 12, wherein the processor is configured to determine the loading information according to a number of user equipments served by the small cell.

14. The small cell according to claim 13, wherein the processor is configured to determine to enter the dormant mode when the number of user equipments served by the small cell is equal to zero.

15. The small cell according to claim 12, wherein the reference signal is a cell reference signal that allows a user equipment to detect the small cell.

16. The small cell according to claim 12, wherein the dormant mode comprises a first time period and a second time period periodically, the communication circuit is configured to broadcast the reference signal in the first time period, and the small cell in configured to disable wireless signal transmission in the second time period.

17. The small cell according to claim 16, wherein length of the second time period is larger than length of the first time period.

18. The small cell according to claim 16, wherein length of the first time period is at least one measurement gap repetition period.

19. The small cell according to claim 16, wherein length of the second time period is at least 1 second.

20. The small cell according to claim 12, wherein the communication circuit is configured to receive the handover request via an S1 interface.

21. The small cell according to claim 12, wherein the communication circuit is configured to receive the handover request via an X2 interface.
